(19) United States
(12) Patent Application Publication
(10) Pub. No.: US 2016/0232708 A1
(43) Pub. Date: Aug. 11, 2016

(54) INTUITIVE INTERACTION APPARATUS AND METHOD

(71) Applicant: ELECTRONICS AND TELECOMMUNICATIONS RESEARCH INSTITUTE, Daejeon (KR)

(72) Inventors: Dae Hwan KIM, Daejeon (KR); Yong Wan KIM, Daejeon (KR); Dong Sik JO, Daejeon (KR); Ki Hong KIM, Sejong-si (KR); Gil Haeng LEE, Seoul (KR)

(21) Appl. No.: 15/014,147

(22) Filed: Feb. 3, 2016

(30) Foreign Application Priority Data
Feb. 5, 2015 (KR) 10-2015-0017966

(51) Int. Cl. G06T 17/10; G06T 19/00; H04N 13/02; G06F 3/01

(52) U.S. Cl. CPC G06T 17/10; G06F 3/013; G06T 19/006; H04N 13/0203

(57) ABSTRACT

Provided are an intuitive interaction apparatus and method. The intuitive interaction apparatus includes a detector configured to detect three-dimensional (3D) information of an object of interest (OOI), including a body part of a first object and an object close to the body part, from a 3D image frame of the first object in an eye-gaze range of the first object and a restorer configured to combine pieces of the 3D information of the OOI detected by the detector and three-dimensionally model the OOI to generate a 3D model which is to be displayed in virtual reality.

### CROSS-REFERENCE TO RELATED APPLICATIONS

This application claims priority under 35 U.S.C. §119 to Korean Patent Application No. 10-2015-0017966, filed on Feb. 5, 2015, the disclosure of which is incorporated herein by reference in its entirety.

### BACKGROUND OF THE INVENTION

1. Field of the Invention

The present invention relates to a virtual reality technology, and more particularly, to an intuitive interaction apparatus and method for displaying a three-dimensional (3D) model, corresponding to an input image, in virtual reality,

2. Description of Related Art

Recently, a natural interface which is natural and has an enhanced interaction is being applied between a human and a computer. Therefore, research on recognition of a user's intention and behavior for an interaction between a human and a computer is being actively done.

Instead of keyboards or mouse which are interaction interfaces, fields of interactive interfaces for providing a more natural computing environment are rapidly growing.

Moreover, the mouse or the keyboards correspond to an indirect interaction where an eye-gaze of a user does not match a manipulation space. On the other hand, a multi-touch and a proximity touch (hovering) provide a direct interaction where an eye-gaze looking at a manipulation target matches a manipulation space, thereby enabling more natural manipulation to be performed.

However, the multi-touch or the proximity touch provides a 2D interaction, and for this reason, is low in senses of immersion and unity of a provided object manipulation service.

Recently, an intuitive interaction method using an immersive display device is being used in combination with technologies such as augmented reality, virtual reality, a computer vision, gesture recognition, and/or the like in various application fields such as movies, games, education, and/or the like.

However, since most methods use a physical touch panel or a physical user interface (PUI), a user should directly touch a button or should directly touch or grasp a specific device.

### SUMMARY

Accordingly, the present invention provides an intuitive interaction apparatus and method for displaying a region of interest (ROI) of a first object in virtual reality.

The object of the present invention is not limited to the aforesaid, but other objects not described herein will be clearly understood by those skilled in the art from descriptions below.

In one general aspect, an intuitive interaction apparatus includes: a detector configured to detect three-dimensional (3D) information of an object of interest (OOI), including a body part of a first object and an object close to the body part, from a 3D image frame of the first object in an eye-gaze range of the first object; and a restorer configured to combine pieces of the 3D information of the OOI detected by the detector and three-dimensionally model the OOI to generate a 3D model which is to be displayed in virtual reality.

In another general aspect, an intuitive interaction apparatus includes: an environment scanner configured to generate a three-dimensional (3D) image frame of a first object from 3D image information obtained by photographing an ambient environment of the first object; and a detector configured to detect a candidate object, approaching a body part of the first object in an eye-gaze range of the first object to within at least a certain distance, from the 3D image frame and extract 3D information of an object of interest (OOI) that includes the body part and the candidate object.

In another general aspect, an intuitive interaction method performed by one or more processors includes: selecting an object, approaching a body part of a first object to within a predetermined distance in an eye-gaze range of the first object, from a three-dimensional (3D) image frame of the first object; detecting 3D information of an object of interest (OOI) that includes the selected object and the body part; and generating a 3D model of the OOI by using the 3D information about a plurality of 3D image frames.

Other features and aspects will be apparent from the following detailed description, the drawings, and the claims.

### BRIEF DESCRIPTION OF THE DRAWINGS

FIG. 1 is a block diagram illustrating an intuitive interaction apparatus according to an embodiment of the present invention.

FIG. 2 is a block diagram illustrating a detailed configuration of a 3D image obtainer illustrated in FIG. 1.

FIG. 3 is a block diagram illustrating a detailed configuration of an environment scanner illustrated in FIG. 1.

FIG. 4 is a block diagram illustrating a detailed configuration of an object detector illustrated in FIG. 1.

FIG. 5 is a block diagram illustrating a detailed configuration of an object restorer illustrated in FIG. 1.

FIG. 6 is a block diagram illustrating a detailed configuration of an object output unit illustrated in FIG. 1.

FIG. 7 is a flowchart illustrating an intuitive interaction method according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

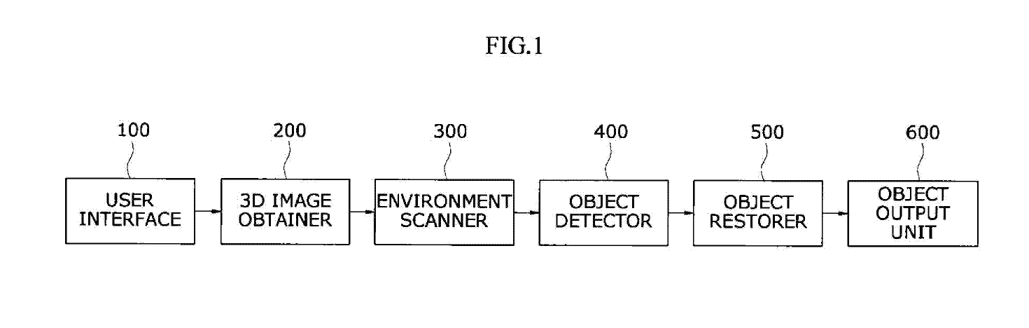

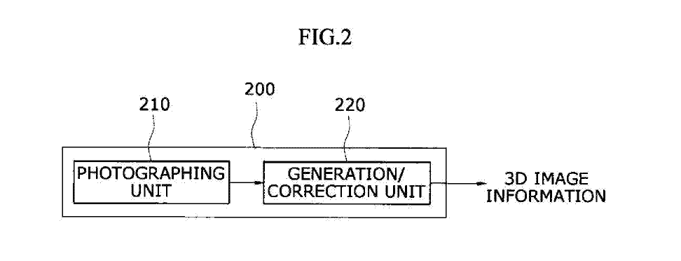

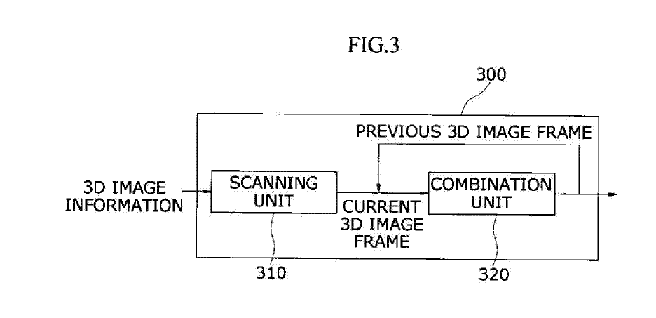

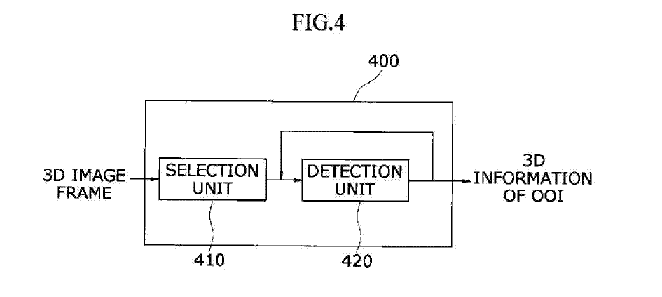

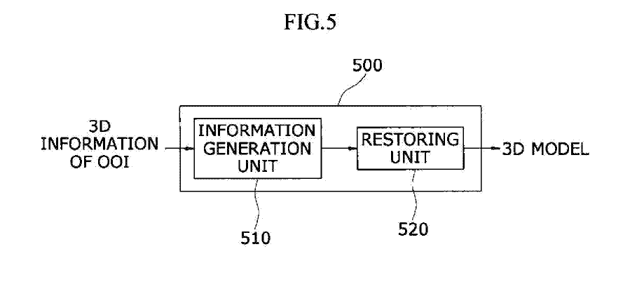

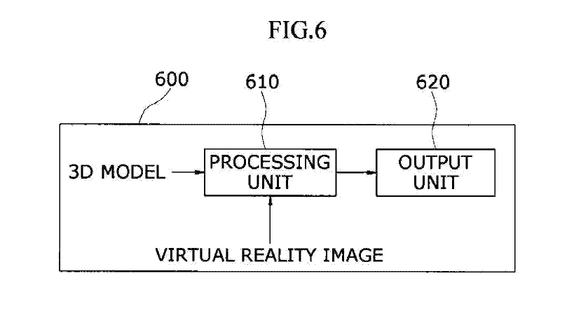

FIG. 1 is a block diagram illustrating an intuitive interaction apparatus according to an embodiment of the present invention. FIG. 2 is a block diagram illustrating a detailed configuration of a 3D image obtainer illustrated in FIG. 1. FIG. 3 is a block diagram illustrating a detailed configuration of an environment scanner illustrated in FIG. 1. FIG. 4 is a block diagram illustrating a detailed configuration of an object detector illustrated in FIG. 1. FIG. 5 is a block diagram illustrating a detailed configuration of an object restorer illustrated in FIG. 1. FIG. 6 is a block diagram illustrating a detailed configuration of an object output unit illustrated in FIG. 1.

As illustrated in FIG. 1, the intuitive interaction apparatus according to an embodiment of the present invention may include a user interface 100, a 3D image obtainer 200, an environment scanner 300, an object detector 400, an object restorer 500, and an object output unit 600. The intuitive interaction apparatus according to an embodiment of the present invention may be applied to wearable devices such as glasses, watches, etc, and may be applied to various kinds of devices.

The user interface 100 may receive, from a user, a selection of virtual reality and a service start or end request according to an embodiment of the present invention. Therefore, a first object or another user may select virtual reality, on which an object of interest (OOI) is overlaid and expressed, through a user interface 100.

The 3D image obtainer 200 may photograph an ambient environment of the first object to obtain 3D image information and may supply the obtained 3D image information to the environment scanner 300. Here, the first object may be a user or an animal that uses the intuitive interaction apparatus according to an embodiment of the present invention.

The 3D image obtainer 200, as illustrated in FIG. 2, may include a photographing unit 210 and a generation/correction unit 220.

The photographing unit 210 may be at least one of a 3D depth camera that obtains a 3D depth image, a multi-camera that obtains a multi-viewpoint 2D image, and a stereo camera that obtains a stereo camera. Also, the photographing unit 210 may be implemented in a type of being detachably attached to a head of the first object. Hereinafter, for convenience of description, a case where the photographing unit 210 is detachably attached to the head of the first object will be described as an example.

For example, when the photographing unit 210 is configured with a manual camera, two cameras (for example, a charge-coupled device (CCD) camera, infrared (IR) camera, and/or the like) having the same type may be disposed in a stereo structure. Alternatively, when the photographing unit 210 uses an active camera, the photographing unit 210 may generate 3D image information including distance information by using Kinect or time of flight (TOF).

When a 2D image is supplied from the photographing unit 210, the generation/correction unit 220 may generate 3D image information from 2D images.

The generation/correction unit 220 may check a disparity of a 2D image supplied from the photographing unit 210 or depth information of an environment corresponding to a 2D image which is checked separately from the photographing unit 210, and may assign depth information, instead of color information or contrast information, to each pixel unit to generate a 3D depth image.

The 3D depth image may be obtained by the following two methods.

A first method is a stereo matching method using the principle that senses a distance of a measurement space and a 3D shape of a measurement object by using images from a pair of cameras as if a human recognizes a three-dimensional space by using a visual cortex in two eyes and brain.

A second method is a method that irradiates a laser in front of a camera and calculates a speed, at which the laser is reflected, to obtain depth information.

In the first method, since the number of operations is large, it is not suitable to obtain accurate depth information in real time, and if an operation speed increases for real-time processing, an accuracy of depth information is reduced.

However, the second method may be used in real time and is high in accuracy, and thus is much used.

In a case where the photographing unit 210 generates two 2D images and depth information is obtained by using the second method, the 3D image obtainer 200 may further include a depth information obtaining unit (not shown) that obtains depth information, based on TOF or Kinect.

Hereinafter, for convenience of description, a case where the photographing unit 210 transfers a 3D image like a 3D depth camera will be described as an example.

When an eye-gaze direction of the first object is changed, the photographing unit 210 may photograph an ambient environment of the first object while moving according to a change in eye-gaze information. In this case, the photographing unit 210 may be actively moved by a motor. Hereinafter, for convenience of description, a case where the photographing unit 210 attached to the head of the first object is manually moved according to a gesture (for example, turning a head) of the first object for changing eye-gaze information will be described as an example.

Hereinabove, a case where the 3D image obtainer 200 includes the photographing unit 210 has been described as an example, but the present embodiment is not limited thereto. In another embodiment, the 3D image obtainer 200 may not include the photographing unit 210 and may control an external photographing unit 210 to obtain a 2D or 3D image.

Since fundamental noise exist in 3D images generated from 2D images or a 3D depth image, the generation/correction unit 220 may correct an image by using various image correction methods.

The environment scanner 300 illustrated in FIG. 1 may generate a 3D image frame by using 3D image information and may detect a feature point from the 3D image frame, based on a predetermined method. Therefore, the environment scanner 300 may generate a plurality of 3D image frames naturally succeeding a previous 3D image frame.

Referring to FIG. 3, the environment scanner 300 according to an embodiment of the present invention may include a scanning unit 310 and a combination unit 320.

The scanning unit 310 may recombine a frame, volume, or a polygon included in the 3D image information supplied from the 3D image obtainer 200 of FIG. 1 to generate a 3D image frame, a 3D image volume, or a 3D image polygon. Here, the 3D image information may Include a 3D coordinate value which has the photographing unit 210 as an original point. Hereinafter, for convenience of description, a case where the scanning unit 310 generates a 3D image frame will be described as an example.

The scanning unit 310 may scan an environment corresponding to at least one-time change in the eye-gaze information of the first object when the eye-gaze information of the first object is changed at least once after a service starts.

The combination unit 320 may receive, from the scanning unit 310, 3D image frames (3D image frames by angle) based on a change in the eye-gaze information, detect feature points having a predetermined type from the 3D image frames, detect a corresponding point between the 3D image frames by angle with respect to the detected feature points, and combine the 3D image frames by angle to generate 3D image frames naturally succeeding a previous 3D image frame. Here, the feature points may include a texture, a color, a shape, a length, an outer line, and a parallel line in the photographed environment.

The scanning unit 310 and the combination unit 320 may each check a change in the eye-gaze information of the first object by additionally using data from a gyro sensor or a pupil sensor.

For example, the intuitive interaction apparatus may recognize, as a change in the eye-gaze information of the first object, a change in a photographing region or a center point of the photographing unit 210 illustrated in FIG. 2. In this case, the intuitive interaction apparatus may further include a gyro sensor (not shown), and when the gyro sensor (not shown) senses a head turn of the first object, information corresponding to the head turn may be transferred to at least one of the scanning unit 310 and the combination unit 320.

As another example, the intuitive interaction apparatus may recognize, as the change in the eye-gaze information of the first object, an iris direction change of the first object irrelevant to the change in the photographing region or center point of the photographing unit 210. In this case, the intuitive interaction apparatus may further include an iris recognition sensor (not shown), and when the iris recognition sensor (not shown) senses a direction change of an iris of the first object, information corresponding to the direction change may be transferred to at least one of the scanning unit 310 and the combination unit 320.

Hereinafter, for convenience of description, a case where the intuitive interaction apparatus recognizes, as the change in the eye-gaze information of the first object, a head direction change of the first object will be described as an example.

The scanning unit 310 may scan only a predetermined distance and range corresponding to a portion of the photographing region of the photographing unit 210 instead of a whole portion of the photographing region. For example, the scanning unit 310 may scan the whole portion of the photographing region before a candidate object and an OOI are selected, and may scan only a region based on an eye-gaze range in an operation of or after selecting the candidate object or the OOI. Therefore, the scanning unit 310 may scan a 3D image frame corresponding to the region (or the OOI) based on the eye-gaze range. In this case, the combination unit 310 may combine a plurality of 3D image frame corresponding to the region (or the OOI) based on the eye-gaze range in order for the 3D image frames to naturally succeed a previous 3D image frame.

The object detector 400 illustrated in FIG. 1 may select a candidate object, which is close to or in contact with a predetermined body part of the first object, from among candidate objects within an eye-gaze range based on eye-gaze information of the first object in the photographing region from the 3D image frame supplied from the combination unit 320 of the environment scanner 300.

Moreover, the object detector 400 may detect 3D information of an OOI including a predetermined body part of the first object and the selected candidate object. Here, the predetermined body part may be at least one of a hand, an arm, a leg, and a foot. Also, the object detector 400 may select a candidate object which is located at a position close to a body part of the first object according to moving and is close to within a predetermined distance. For example, the predetermined distance may be 20 cm. The predetermined distance may be set as a slightly long distance when the first object moves dynamically, and when the first object does not move, the predetermined distance may be set as a short distance.

A configuration and an operation of the object detector 400 will be described in more detail with reference to FIG. 4.

Referring to FIG. 4, the object detector 400 may include a selection unit 410 and a detection unit 420.

The selection unit 410 may select an OOI, which is located near a body part of the first object or includes a body part and at least one candidate object contacting the body part, from among objects within an eye-gaze range of the first object in the photographing region of the photographing unit 210 from the 3D image frame.

Here, the OOI may be one of various objects such as an object, an animal, and/or the like located in the photographing region. Also, the eye-gaze range may be within a certain radius, which is expected to face an eye-gaze of a user, in a whole photographable region. Also, eye-gaze information of the first object may be information sensed by a gyro sensor or information sensed through tracking of an ambient environment by the environment scanner 300. For example, when a field of view (FOV) of the photographing unit 210 is 50 degrees with respect to each of up, down, left, and right sides, the eye-gaze range may be within 45 degrees (generally, a view angle of a human) with respect to a center point of the eye-gaze of the first object which is predicted based on information sensed by a gyro sensor (not shown) or an iris recognition sensor (not shown).

In detail, the selection unit 410 may detect at least one candidate object which is one of all objects located within an eye-gaze range based on the eye-gaze information of the first object in the photographing region from the 3D image frame supplied from the environment scanner 300.

Moreover, the selection unit 410 may detect at least one proximity object, which is located close to a body part of the first object in a moving direction of the body part or contacts the body part, from among candidate objects within the detected eye-gaze range.

The selection unit 410 may select an OOI which includes the detected at least one OOI and the body part of the first object.

For example, when a user (the first object) stretches a hand for grasping a cup on a table, the selection unit 410 may select, as proximity objects, the cup located in a moving direction of the user's hand and a book located behind the cup. Also, the selection unit 410 may select, as OOIs, at least a portion of each of a hand and arm of the user and the cup.

For example, when a 3D image frame which includes a body part of the first object and a proximity object is supplied from the environment scanner 300, the selection unit 410 may select an OOI from the 3D image frame.

The detection unit 420 of the object detector 400 may detect and track a candidate object, a proximity object, and an OOI which are located within the eye-gaze range. In this case, the detection unit 420 may compare pieces of detection feature information (a texture, a color, a shape, a length, an outer line, and a parallel line) of one of a candidate object, a proximity object, and an OOI, which are located within an eye-gaze range, with pieces of tracking feature information for tracking a target object in a previous image frame and a current image frame, thereby detecting a body part and the target object.

For example, the tracking of the target object may be performed by comparing and analyzing a similarity between tracking features of a current image frame and tracking features of a previous image frame.

As described above, the detection unit 420 may compare and track features detected through an association-based tracking process, thereby accurately tracking a covered target object. Here, the detection unit 420 may store information of the target object, which may be used to track a next image frame.

As a result, the detection unit 420 may transfer 3D information of the OOI, such as a 3D coordinate value or a range value of an OOI, to the object restorer 500.

For example, when the selection unit 410 finally checks a candidate object contacting a body part of the first object, the detection unit 420 may not detect or track another object.

The object restorer 500 illustrated in FIG. 1 may model an OOI into a 3D model which is to be expressed in virtual reality, based on 3D information of the OOI. Here, the 3D information of the OOI may be 3D volume data of the OOI.

A configuration and detailed operation of the object restorer 500 will be described with reference to FIG. 5.

Referring to FIG. 5, the object restorer 500 may include an information generation unit 510 and a restoring unit 520.

The information generation unit 510 may generate a plurality of polygons and textures corresponding to each image frame, based on 3D information of an OOI supplied from the object detector 400.

The restoring unit 520 may check and finish an OOI covered by a hand and/or the like to finish a 3D model of the OOI, based on the generated plurality of polygons and textures corresponding to each image frame. In this case, even when the 3D model of the OOI is not finished based on a current image frame due to the OOI being covered by a hand and/or the like, the restoring unit 520 may transfer a currently generated 3D model of the OOI to the object output unit 600. Therefore, the object output unit 600 may three-dimensionally display the OOI.

As described above, in an embodiment of the present invention, since the OOI is covered by the hand and/or the like, a progressive 3D modeling method of finishing the OOI which is covered by a body part of the first object according to a gesture of the body part may be used.

The object output unit 600 illustrated in FIG. 1 may match a 3D model of an OOI, generated by the object restorer 500, with virtual reality to display the matched 3D model.

The object output unit 600, as illustrated in FIG. 6, may include a processing unit 610 and an output unit 620,

The processing unit 610 may perform texturing on the 3D model of the OOI to assimilate the 3D model with objects in virtual reality. Therefore, in an embodiment of the present invention, an OOI is processed to naturally match an image in virtual reality.

In detail, the processing unit 610 may rotate the 3D model of the OOI to determine a position, based on the eye-gaze information of the first object.

Moreover, the processing unit 610 may locate the 3D model, rotated by a predetermined angle, at the determined position based on the eye-gaze information of the first object. Therefore, in an embodiment of the present invention, an OOI is naturally displayed like directly looking at the OOI with eyes of the first object which is looking at virtual reality.

The output unit 620 may be a display that displays a 3D image, and may display an image generated by the processing unit 610. For example, the output unit 620 may be a display having a sunglasses form and may provide virtual reality to the first object while covering a field of view of the first object.

### DETAILED EMBODIMENT OF THE INVENTION

Hereinafter, a detailed embodiment of the present invention will be described.

The intuitive interaction, apparatus according to an embodiment of the present invention may be configured in a glasses form. A user may wear the intuitive interaction apparatus like glasses and may feel like using a notebook computer in a meadow in an operation of manipulating the notebook computer. The intuitive interaction apparatus may display a 3D meadow image as wallpaper in virtual reality, detect, as OOIs, a notebook computer manipulated by a user and a desk on which the notebook computer is located, and generate a 3D model corresponding to each of the OOIs. Here, the intuitive interaction apparatus may generate a body part of a user, which is seen in a current field of view of the user, as a 3D model in a similar form seen in the current field of view of the user like a notebook computer, a desk, and a hand and an arm of the user which are manipulating the notebook computer. Subsequently, the intuitive interaction apparatus may combine the generated 3D model with virtual reality to display an OOI in order for the user to feel like using the notebook computer in a meadow.

Moreover, the user may turn a head and may stretch a hand for a mug cup for drinking coffee while using the notebook computer.

In this case, the intuitive interaction apparatus may check the head turn of the user, based on at least one of gyro information and a detected feature point of an external environment and may detect all objects within a current eye-gaze range based on the turn of the head.

Moreover, while displaying the objects within the eye-gaze range, the intuitive interaction apparatus may detect and display candidate objects close to the hand of the user and may check, as an OOI, the mug cup contacting the hand of the user.

As another example, a user may use the intuitive interaction apparatus so as to feel like playing soccer on a soccer field.

In this case, the user may select the soccer field as virtual reality and may touch a soccer ball, and thus, the intuitive interaction apparatus may select, as OOIs, the soccer ball and a body part of the user which is close to and in contact with the soccer ball. The intuitive interaction apparatus may scan an ambient environment of the user at an initial stage and then may check objects near the user. Subsequently, the intuitive interaction apparatus may display a 3D soccer field image and may three-dimensionally model and display the soccer ball close to the user and the body part of the user contacting the soccer ball. When there is an object which is close to the user and is capable of bumping against the user while playing soccer with the soccer ball, the intuitive interaction apparatus may three-dimensionally model the close object and may mark the object on the 3D soccer field image in order for the user not to bump against the close object. At this time, the intuitive interaction apparatus may monitor an object located at a predetermined distance, based on a moving speed of the user.

As described above, in an embodiment of the present invention, an intuitive interaction interface for a user may be provided in an immersive display apparatus, which enables the user to freely use both hands like Google Glasses, or an immersive display apparatus which is applied to a wearable computer and is disconnected from the outside.

Moreover, in an embodiment of the present invention, an ROI of a user is accurately detected and restored through image analysis, thereby providing an interaction service which is more natural and intuitive and is high in convenience.

In addition, in an embodiment of the present invention, some of external environments close to a body part of a user may be monitored without continuously scanning all the external environments, thereby providing an intuitive interaction interface based on a request of the user.

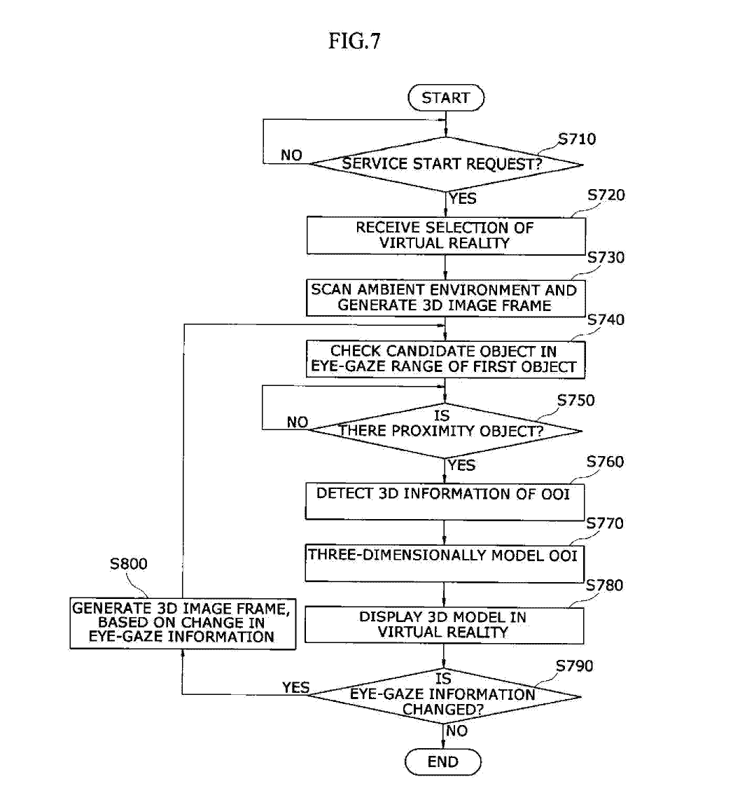

Hereinafter, an intuitive interaction method according to an embodiment of the present invention will be described with reference to FIG. 7. FIG. 7 is a flowchart illustrating an intuitive interaction method according to an embodiment of the present invention. In FIG. 7, a case where the intuitive interaction apparatus is worn on eyes of a first object in a glasses form will be described as an example.

Referring to FIG. 7, when a request to start a service is issued through the user interface 100 in step S710, one virtual reality may be selected from among virtual realities able to be provided in step S720.

In step S730, the environment scanner 300 may photograph and scan an ambient environment of the first object and may generate a 3D image frame corresponding to the scanned ambient environment. Here, steps S720 and S730 may be simultaneously performed. Alternatively, one of steps s720 and S730 may be first performed, and the other may be performed later. In this case, the object output unit 600 may display virtual reality, and since a separate screen is not displayed, an eye-gaze of the first object may not be covered.

In step S740, the object detector 400 may check initial eye-gaze information of the first object, based on 3D image information of the scanned ambient environment and may check a candidate object located within an eye-gaze range based on the initial eye-gaze information. Here, the object output unit 600 may display the candidate object in virtual reality, and since a separate screen is not displayed, the eye-gaze of the first object may not be covered.

In step S750, the object detector 400 may check whether a body part of the first object among candidate objects located within an eye-gaze range is located within an approachable range or there is an object contacting the body part. Here, the object output unit 600 may display the candidate object in virtual reality, and since a separate screen is not displayed, the eye-gaze of the first object may not be covered. In this case, an OOI may include a part of a body.

When it is checked in step S750 that there is an OOI, the object detector 400 may detect and track a proximity object and the OOI including a part of a body to detect 3D information of the OOI in step S760.

In step S770, the object restorer 500 may three-dimensionally model the OOI to generate a 3D model of the OOI, based on the 3D information of the OOI which is detected in step S760.

In step S780, the object detector 600 may perform texturing on the 3D model of the OOI which is generated in step S770, thereby displaying the textured 3D model in the virtual reality. Therefore, in an embodiment of the present invention, an OOI is processed to naturally match an image in virtual reality.

In this case, in addition to performing texturing for assimilating the OOI with objects in the virtual reality, the object output unit 600 may rotate the 3D model of the OOI to determine a position at which the 3D model is displayed in the virtual reality, based on eye-gaze information of the first object and may locate the 3D model, rotated by a predetermined angle, at the determined position based on the eye-gaze information of the first object. Therefore, in an embodiment of the present invention, an OOI is naturally displayed like directly looking at the OOI with eyes of the first object which is looking at the virtual reality.

When eye-gaze information of a user is changed while displaying the OOI in the virtual reality, the object detector 400 may check a change in the eye-gaze information, based on changes in X, Y, and Z directions from a gyro sensor or a change in a photographed environment in step S790.

In step S800, the environment scanner 300 may generate a plurality of 3D image frames naturally succeeding a previous 3D image frame, based on a change in the eye-gaze information from a 3D image which is captured while moving according to the change in the eye-gaze information.

Subsequently, the object detector 400 may three-dimensionally model an OOI, changed according to the eye-gaze information, through an operation which is the same as or similar to steps S740 to S780, and may express the modeled OOI in the virtual reality.

As described above, information according to an embodiment of the present invention may be used as information for an interaction based on ambient environment data (an object and a body part of the object) in an immersive apparatus, and may be used as basis information of an interaction necessary for wearable computers, augmented reality, virtual reality, gesture recognition, human-robot interfaces (HMIs), human-computer interfaces (HCIs), artificial intelligence fields, and/or the like.

In addition, according to the embodiments of the present invention, a more natural restoration result is shown in a video-see-through head mount display in comparison with the related art.

Furthermore, according to the embodiments of the present invention, since only environment data which is intelligently selected is restored, a calculation time is shortened, and a natural interaction with an environment is induced.

According to the embodiments of the present invention, an ROI of a first object may be expressed in virtual reality.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An intuitive interaction apparatus comprising:
a detector configured to detect three-dimensional (3D) information of an object of interest (OOI), including a body part of a first object and an object close to the body part, from a 3D image frame of the first object in an eye-gaze range of the first object; and
a restorer configured to combine pieces of the 3D information of the OOI detected by the detector and three-dimensionally model the OOI to generate a 3D model which is to be displayed in virtual reality.

2. The intuitive interaction apparatus of claim 1, further comprising: an image obtainer configured to obtain a 3D image of an ambient environment of the first object.

3. The intuitive interaction apparatus of claim 2, further comprising: an environment scanner configured to generate a 3D image frame by using 3D image information obtained by the image obtainer to detect a feature point having a predetermined type from the 3D image frame,
wherein the environment scanner comprises:
a scanning unit configured to, when it is checked that eye-gaze information of the first object is changed, generate a 3D image frame of the ambient environment of the first object, based on a change in the eye-gaze information; and
a combination unit configured to combine the 3D image frame and a previous 3D image frame based on the detected feature point to generate the 3D image frame of the first object.

4. The intuitive interaction apparatus of claim 1, further comprising: a gyro sensor or an iris recognition sensor configured to sense a change in the eye-gaze range of the first object.

5. The intuitive interaction apparatus of claim 1, wherein
the 3D image frame of the first object is a 3D image frame photographed in a photographing range of a camera that photographs an ambient environment of the first object, and
when there is no candidate object contacting the body part of the first object among a plurality of candidate objects located in an eye-gaze range based on eye-gaze information of the first object in the photographing region, the detector selects, as the OOI, the body part and a candidate object close to the body part.

6. The intuitive interaction apparatus of claim 5, wherein when there is the candidate object contacting the body part of the first object among the plurality of candidate objects located in the eye-gaze range, the detector selects, as the OOI, the body part and the candidate object contacting the body part.

7. The intuitive interaction apparatus of claim 1, wherein the restorer comprises:
an information generation unit configured to generate a polygon and a texture from the 3D information of the OOI; and
a restoring unit configured to three-dimensionally model the OOI by using the polygon and the texture.

8. The intuitive interaction apparatus of claim I, further comprising: an output unit configured to match the 3D model with virtual reality, wherein the output unit assimilates a heterogeneous texture of a region, where the 3D model in the virtual reality is to be located, with the 3D model and outputs the 3D model.

9. An intuitive interaction apparatus comprising:
an environment scanner configured to generate a three-dimensional (3D) image frame of a first object from 3D image information obtained by photographing an ambient environment of the first object; and
a detector configured to detect a candidate object, approaching a body part of the first object in an eye-gaze range of the first object to within at least a certain distance, from the 3D image frame and extract 3D information of an object of interest (OOI) that includes the body part and the candidate object.

10. The intuitive interaction apparatus of claim 9, further comprising:
a restorer configured to three-dimensionally model the OOI to generate a 3D model of the OOI, based on the 3D information of the OOI; and
an output unit configured to display the 3D model of the OOI in 3D virtual reality.

11. The intuitive interaction apparatus of claim 9, wherein
when it is checked that eye-gaze information of the first object is changed, the environment scanner generates the 3D image frame of a whole photographing region capable of being photographed by a camera, and
when the OOI is checked, the environment scanner generates the 3D image frame of a region including the OOI in the whole photographing region.

12. The intuitive interaction apparatus of claim 11, wherein the environment scanner checks a change in the eye-gaze information by using a gyro sensor or an iris recognition sensor that senses a change in the eye-gaze range of the first object.

13. The intuitive interaction apparatus of claim 11, wherein the detector detects a feature point from the 3D image information and allows the current 3D image frame to succeed a previous 3D image frame by using a method of matching the detected feature point, based on the change in the eye-gaze information of the first object.

14. An intuitive interaction method performed by one or more processors, the intuitive interaction method comprising:
selecting an object, approaching a body part of a first object to within a predetermined distance in an eye-gaze range of the first object, from a three-dimensional (3D) image frame of the first object;
detecting 3D information of an object of interest (OOI) that includes the selected object and the body part; and
generating a 3D model of the OOI by using the 3D information about a plurality of 3D image frames.

15. The intuitive interaction method of claim 14, further comprising: matching the 3D model of the OOI with virtual reality to display the 3D model.

16. The intuitive interaction method of claim 14, further comprising: generating the 3D image frame, corresponding to all or a portion of a photographed external environment, from 3D image information obtained by a camera.

17. The intuitive interaction method of claim 16, further comprising:
when it is checked that eye-gaze information of the first object is changed, generating the 3D image frame corresponding to all of the external environment; and
when the OOI is checked, generating the 3D image frame of a region including the OOI in the external environment.

18. The intuitive interaction method of claim 14, further comprising:
detecting a feature point from the 3D image information obtained by a camera; and
allowing the current 3D image frame to succeed a previous 3D image frame by using a method of matching the detected feature point, based on the change in the eye-gaze information of the first object.

19. The intuitive interaction method of claim 14, wherein the selecting comprises:
checking whether there is a candidate object contacting the body part of the first object among a plurality of candidate objects located in an eye-gaze of the first object in the 3D image frame; and
when there is no candidate object contacting the body part, selecting the body part and a candidate object close to the body part as the OOI.

20. The intuitive interaction method of claim 19, wherein the selecting comprises, when there is the candidate object contacting the body part of the first object among the plurality of candidate objects located in the eye-gaze range, selecting the body part and the candidate object contacting the body part as the OOI.
